(19) United States
(12) Patent Application Publication
(10) Pub. No.: US 2025/0278576 A1
(43) Pub. Date: Sep. 4, 2025

(54) UTILIZING INTELLIGENT DIGITAL CONTENT ANALYSIS AND LARGE LANGUAGE MODELS TO RESOLVE TRANSACTION DISPUTES

(71) Applicant: Marqeta, Inc., Oakland, CA (US)

(72) Inventors: Ashok Kumar, Pleasanton, CA (US); Sangeetha Raghavan, Wintergarden, FL (US); Dongming Shu, Highland Park, NJ (US); Pranav A. Patel, Pleasanton, CA (US)

(21) Appl. No.: 18/594,764

(22) Filed: Mar. 4, 2024

(51) Int. Cl. G06F 40/40; G06F 40/30

(52) U.S. Cl. CPC G06F 40/40; G06F 40/30

(57) ABSTRACT

This disclosure describes methods, non-transitory computer readable storage media, and systems that use intelligent digital content analysis and large language models to resolve transaction disputes. The disclosed system selects appropriate digital content analysis tools for analyzing digital documentation including details of a transaction in response to a transaction dispute. The disclosed system utilizes data extracted from the digital documentation to generate a number and type(s) of model prompts to provide to a large language model based on attributes of the transaction dispute. The disclosed system uses responses generated by the large language model for the model prompts to determine a dispute resolution operation (e.g., approval, denial, or agent review). Furthermore, the disclosed system provides a response to the request to one or more computing devices associated with the request in response to execution of the dispute resolution operation.

### BACKGROUND

Improvements in computing technology have led to an increase in the use of electronic payment transactions in a number of different circumstances. The prevalence of electronic payment transactions has also led to many entities providing increased access to payment cards (e.g., credit cards or debit cards) for consumers to use with merchants and other recipients. Due to the increased prevalence of use and availability of electronic payment transactions, the number of disputes for such transactions has also increased as a result of human and device errors. For instance, transaction disputes can include a merchant or a cardholder requesting a change to a previously processed transaction based on allegations of conflicting payment amounts, undelivered or defective products, fraud, etc. Resolving disputes for electronic payment transactions often involves various communications between computing systems involved in processing electronic payment transactions (e.g., merchant systems, consumer devices, and acquirer systems) to exchange various requests, digital documentation, and responses.

Conventional systems encounter several disadvantages related to processing transaction disputes for electronic payment transactions while also ensuring compliance with various digital data requirements (e.g., PCI industry standards) related to processing, transmitting, storing, or otherwise handling certain types of digital data. For example, conventional systems lack the ability to accurately and efficiently accessing digital documentation related to disputes or downloading and extracting information from the digital documentation, which can cause compliance issues with digital data requirements or lead to inaccurate results. Additionally, many conventional systems lack the ability to quickly resolve disputes, which can lead to issues with downstream computing or transaction operations that rely on timely resolutions.

### SUMMARY

This disclosure describes one or more embodiments of methods, non-transitory computer readable media, and systems that solves one or more of the foregoing problems (in addition to providing other benefits). In one or more embodiments, in response to a request indicating a transaction dispute for an electronic payment transaction, the disclosed systems select appropriate digital content analysis tools for analyzing digital documentation including details of the transaction. The disclosed systems utilize data extracted from the digital documentation to generate a number and type(s) of model prompts to provide to a large language model based on attributes of the transaction dispute. Additionally, the disclosed systems use responses generated by the large language model for the model prompts to determine a dispute resolution operation (e.g., approval, denial, or agent review). Furthermore, in one or more embodiments, the disclosed systems provide a response to the request to one or more computing devices associated with the request in response to execution of the dispute resolution operation. By utilizing intelligent digital content analysis of transaction dispute documentation with a large language model to determine and execute dispute resolution operations for transaction disputes, the disclosed systems provide fast, flexible, and accurate digital document processing and dispute resolution automation.

### BRIEF DESCRIPTION OF THE DRAWINGS

The detailed description refers to the drawings briefly described below.

FIG. 1 illustrates a block diagram of a system environment in which a machine-learning dispute system is implemented in accordance with one or more implementations.

FIG. 2 illustrates a diagram of an overview of the machine-learning dispute system utilizing intelligent digital content analysis and a large language model to determine a dispute resolution operation for a transaction dispute in accordance with one or more implementations.

FIG. 3 illustrates a diagram of the machine-learning dispute system utilizing digital content analysis tools to extract data from digital documents associated with a transaction dispute in accordance with one or more implementations.

FIG. 4 illustrates a diagram of the machine-learning dispute system generating model prompts based on text descriptions of digital documents in accordance with one or more implementations.

FIG. 5 illustrates a diagram of the machine-learning dispute system utilizing a large language model to determine a dispute resolution operation for a transaction dispute in accordance with one or more implementations.

FIG. 6 illustrates a diagram of the machine-learning dispute system generating a digital image summary of relevant portions of digital documents associated with a transaction dispute in accordance with one or more implementations.

FIG. 7 illustrates a diagram of a process for utilizing feedback from an agent client device to learn parameters of one or more models of the machine-learning dispute system in accordance with one or more implementations.

FIG. 8 illustrate a flowchart of a series of acts for utilizing intelligent digital content analysis and a large language model to resolve a transaction dispute in accordance with one or more implementations.

FIG. 9 illustrates a block diagram of an exemplary computing device in accordance with one or more implementations.

### DETAILED DESCRIPTION

This disclosure describes one or more embodiments of a machine-learning dispute system that utilizes machine-learning to intelligently analyze digital content associated with a transaction dispute and determine dispute resolution operations for resolving the transaction dispute. In particular, the machine-learning dispute system selects digital content analysis tools to analyze and extract data from digital documents (e.g., digital images or scanned documents) associated with a transaction dispute. Additionally, the machine-learning dispute system utilizes the extracted data (e.g., text descriptions or other relevant information associated with the digital documents) to generate model prompts to provide to a large language model in connection with the transaction dispute. The machine-learning dispute system utilizes responses generated by the large language model for the model prompts to determine a dispute resolution operation, such as by utilizing a decision tree, and execute the dispute resolution operation. Furthermore, the machine-learning dispute system provides a response to the request to a computing device associated with the request in response to execution of the dispute resolution operation, such as by providing an approval/denial message or additional information to a client device of a user requesting the transaction dispute or an agent assisting with the transaction dispute.

As mentioned, the machine-learning dispute system intelligently analyzes digital documentation in a dispute for an electronic payment transaction. Specifically, the machine-learning dispute system selects one or more digital content analysis tools to analyze digital documents that include details of a transaction for a transaction dispute. For example, the machine-learning dispute system utilizes information in a request comprising an indication of the transaction dispute (e.g., a reason code) and/or details of one or more digital documents to select specific digital content analysis tools and extract data from the digital documents.

Furthermore, the machine-learning dispute system utilizes the data extracted from the digital documents to generate one or more model prompts. In one or more embodiments, the machine-learning dispute system utilizes a machine-learning model to determine a number and types of model prompts to provide to a large language model. For example, the machine-learning dispute system can generate one or more model prompts in one or more predetermined formats and/or including requests to determine whether the extracted data meets one or more requirements of the transaction dispute. In additional embodiments, the machine-learning dispute system redacts one or more data types (e.g., personally identifiable information) from the extracted data prior to providing the model prompts to the large language model.

In additional embodiments, the machine-learning dispute system determines a dispute resolution operation in connection with the dispute resolution according to the model prompt(s). For instance, the machine-learning dispute system determines whether to approve or deny the transaction dispute (e.g., automatically and without additional intervention) based on outputs of the large language model. Additionally, in some examples, the machine-learning dispute system determines whether to provide the transaction dispute and extracted data to an agent client device for review. In response to executing the dispute resolution operation, the machine-learning dispute system provides a response to the request to one or more computing devices associated with the request (e.g., the agent client device and/or a user client device).

The disclosed machine-learning dispute system provides a number of benefits over conventional systems. For example, the machine-learning dispute system improves the flexibility and efficiency of computing systems that manage and process transaction disputes for electronic payment transactions. In contrast to existing systems that rigidly process transaction disputes and rely on agent discretion for every dispute, the machine-learning dispute system provides adaptable transaction dispute resolution processes based on the provided digital documentation. Specifically, the machine-learning dispute system utilizes machine learning to intelligently select the appropriate digital content analysis tools and generate model prompts to provide to a large language model. Additionally, the machine-learning dispute system also utilizes a large language model to determine whether to automatically approve or deny a transaction dispute based on data extracted from the digital documents utilizing the digital content analysis tools, or whether to provide the transaction dispute to a client device for further review.

In some embodiments, the disclosed machine-learning dispute system also improves the efficiency and accuracy of computing systems involved in processing transaction disputes. In particular, in contrast to conventional systems that merely collect and pass through data for transaction disputes, the machine-learning dispute system utilizes machine learning to assist in identifying relevant data in digital documentation and/or automatically resolve transaction disputes through intelligent digital content analysis. For instance, in some embodiments, the machine-learning dispute system utilizes a machine-learning model to extract data from digital documents and generate model prompts (including digitally generated text descriptions of the digital documents) for a transaction dispute. Furthermore, the machine-learning model utilizes a large language model to accurately analyze the content of the digital documents provided with the transaction dispute in view of various requirements for the transaction dispute and determine a particular dispute resolution operation. The machine-learning dispute system can also automatically identify and redact specific data types from extracted data (e.g., for ensuring compliance with various digital data requirements) prior to providing model prompts to a large language model to prevent the large language model from having access to such data types.

Additionally, the machine-learning dispute system provides improved efficiency over conventional systems via detection and display of relevant data in digital documents. For example, the machine-learning dispute system utilizes intelligent digital content analysis to identify, highlight, and provide portions of digital documents that are relevant to a given transaction dispute to a client device (e.g., an agent client device). Thus, unlike conventional systems that merely collect and display evidence for transaction disputes, the machine-learning dispute system utilizes digital content analysis tools and machine learning to find and display only relevant information. Given that transaction disputes can sometimes have a number of different digital documents with varying sizes, the machine-learning dispute system can reduce the amount of data downloaded and presented to a client device for resolving a transaction dispute. Additionally, the machine-learning dispute system can prevent unnecessary communications with certain devices based on the determined operations to resolve transaction disputes (e.g., by preventing communication with a computing device of a payment network). Furthermore, the machine-learning dispute system provides an improved graphical user interface by automatically obtaining and consolidating relevant information from various digital documents associated with the transaction dispute into a single graphical user interface.

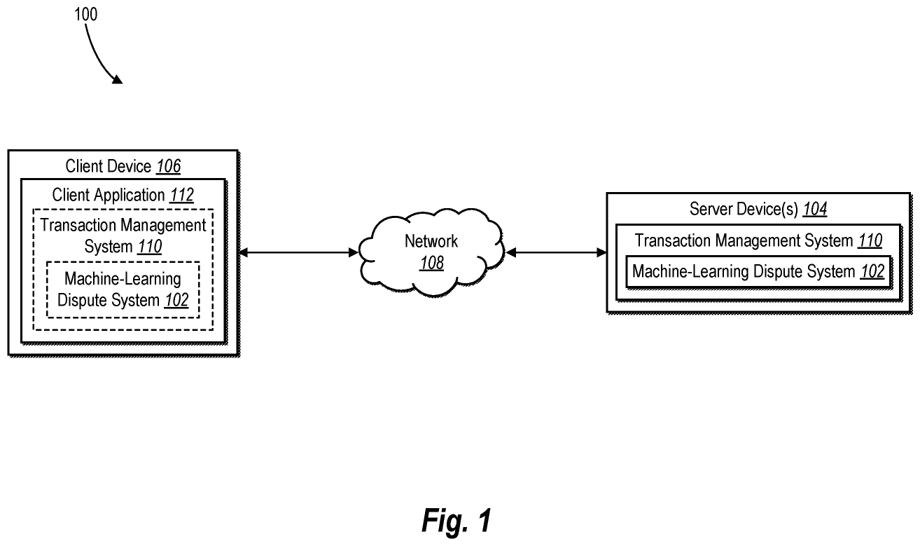

Turning now to the figures, FIG. 1 includes an embodiment of a system environment 100 in which a machine-learning dispute system 102 operates. In particular, the system environment 100 includes server(s) 104 and a client device 106 in communication via a network 108. FIG. 1 illustrates that the machine-learning dispute system 102 is part of a transaction management system 110. Moreover, in one or more embodiments, the client device 106 includes a client application 112.

As shown in FIG. 1, the server(s) 104 include or host the transaction management system 110. The server(s) 104 communicate with one or more other components in the system environment 100 to facilitate processing, reporting, disputing, or other management operations associated with electronic payment transactions. Specifically, the transaction management system 110 includes a processing application that authorizes/declines electronic payment transactions (e.g., involving a payment account), such as by communicating with a payment network. In one or more embodiments, the transaction management system 110 communicates with a payment network to initiate/process electronic payment transactions (e.g., in response to a computing device providing a transaction request to the transaction management system 110). For example, a user client device (e.g., a smartphone or other mobile device) or a merchant device (e.g., a point-of-sale device) communicates with the transaction management system 110 to initiate and process a payment transaction involving a payment card account or other payment account.

In one or more embodiments, the payment network includes one or more payment gateway systems, one or more payment card networks (e.g., VISA, MASTERCARD), and/or one or more card issuer systems (e.g., bank issuers) to process electronic card transactions in connection with the transaction management system 110. The payment network includes one or more servers to generate, store, and transmit data associated with initiating and processing electronic payment transactions via the transaction management system 110. In some embodiments, the transaction management system 110 communicates with one or more additional participant systems (e.g., a third-party system) to initiate/process transactions involving the payment card accounts. In one or more embodiments, a third-party system manages funds or ledgers associated with the payment card accounts.

As used herein, the terms “transaction” and “electronic payment transaction” refer to a computer-based processing operation involving a payment account. To illustrate, a transaction can include an electronic payment transaction to transfer funds from a payment account to a recipient account (or vice-versa).

In one or more embodiments, in connection with processing transactions involving payment card accounts, the transaction management system 110 utilizes the machine-learning dispute system 102 to manage transaction disputes for transactions. For example, in connection with a previously initiated or processed electronic payment transaction, the machine-learning dispute system 102 receives data including evidence for a transaction dispute and determines how to resolve the transaction dispute. As used herein, the term “transaction dispute” refers to a process for determining whether to reverse, cancel, or otherwise nullify a transaction. To illustrate, a transaction dispute involves an electronic request to the machine-learning dispute system 102 to process one or more digital documents including details of a transaction for reversing or canceling the transaction.

In one or more embodiments, the machine-learning dispute system 102 communicates with one or more devices in connection with resolving a transaction dispute. For example, the machine-learning dispute system 102 communicates with the client device 106 to provide data associated with reviewing the transaction dispute or for providing other data associated with a dispute resolution operation (e.g., via the client application 112).

As used herein, the term “dispute resolution operation” refers to an operation implemented by a computing device (e.g., a software application) in connection with resolving a transaction dispute. In some embodiments, a dispute resolution operation involves communicating with one or more computing devices to automatically execute instructions to resolve a transaction dispute, such as by communicating with a payment network to approve the transaction dispute or by communicating with a computing device that initiated the transaction dispute to deny the transaction dispute. A dispute resolution operation can also include generating computing instructions to provide to another computing device to resolve a transaction dispute, such as by generating a summary of the transaction dispute and digital documentation to provide to an agent client device.

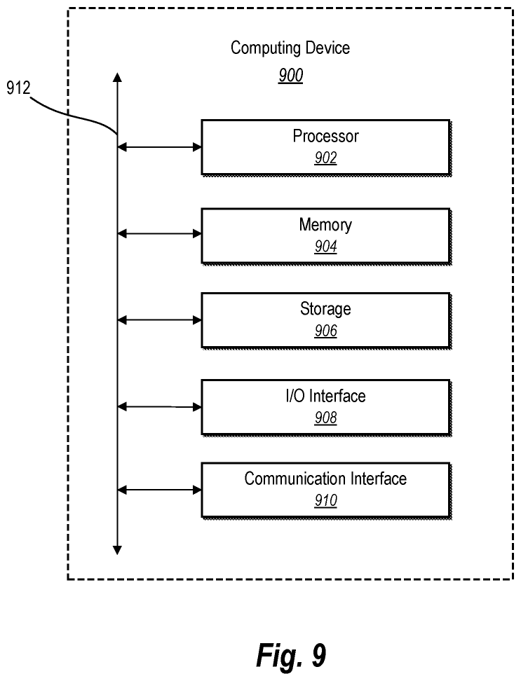

In one or more embodiments, the server(s) 104 include a variety of computing devices, including those described below with reference to FIG. 9. For example, the server(s) 104 includes one or more servers for storing and processing data associated with payment accounts and/or transactions. In some embodiments, the server(s) 104 also include a plurality of computing devices in communication with each other, such as in a distributed storage environment. In some embodiments, the server(s) 104 communicate with a plurality of issuing systems and issuing system devices or other systems and devices of one or more entities based on established relationships between the transaction management system 110, the machine-learning dispute system 102, and the one or more entities. To illustrate, the server(s) 104 communicate with various entities or systems including financial institutions (e.g., issuing banks associated with payment cards via the payment network), payment card networks associated with processing payment transactions involving payment accounts, payment cards, payment gateways, merchant systems, client devices, or other systems.

In addition, in one or more embodiments, the transaction management system 110 and/or the machine-learning dispute system 102 are implemented on one or more servers. For example, the transaction management system 110 and/or the machine-learning dispute system 102 can be partially or fully implemented on a plurality of servers. To illustrate, the transaction management system 110 and the machine-learning dispute system 102 can be implemented in a distributed environment. In one or more embodiments, each server handles requests for managing transactions or transaction disputes. Furthermore, in one or more embodiments, the transaction management system 110 and/or the machine-learning dispute system 102 include or communicate with a plurality of servers in a distribute database for storing data associated with transactions and transaction disputes.

In one or more embodiments, the client device 106 includes a computing device that initiates or manages electronic payment transactions or transaction disputes. For example, the client device 106 includes a user device or a merchant device that enables electronic payment transactions with one or more entities (e.g., via web applications or standalone applications). In some embodiments, the client device 106 includes an agent client device that hosts a web application or standalone applications and communicates with a payment network to manage transaction disputes for electronic payment transactions.

Additionally, as shown in FIG. 1, the system environment 100 includes the network 108. The network 108 enables communication between components of the system environment 100. In one or more embodiments, the network 108 may include the Internet or World Wide Web. Additionally, the network 108 can include various types of networks that use various communication technology and protocols, such as a corporate intranet, a virtual private network (VPN), a local area network (LAN), a wireless local network (WLAN), a cellular network, a wide area network (WAN), a metropolitan area network (MAN), or a combination of two or more such networks. Indeed, the server(s) 104, the transaction management system 110, the machine-learning dispute system 102, and the client device 106 communicate via the network 108 using one or more communication platforms and technologies suitable for transporting data and/or communication signals, including any known communication technologies, devices, media, and protocols supportive of data communications, examples of which are described with reference to FIG. 9. Additionally, in one or more embodiments, one or more of the various components of the system environment 100 communicate using protocols for financial information communications such as PCI standards or other protocols.

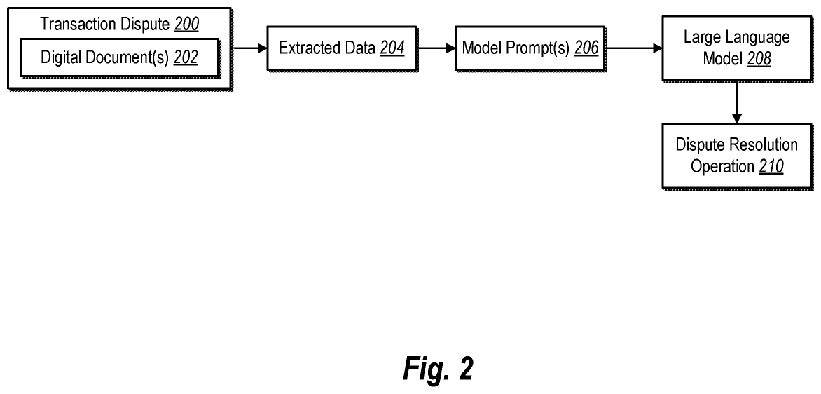

As mentioned, the machine-learning dispute system 102 determines, and in some cases executes, dispute resolution operations associated with revolving transaction disputes for electronic payment transactions. FIG. 2 illustrates an overview of the machine-learning dispute system 102 utilizing one or more machine-learning models for determining a dispute resolution operation for a transaction dispute. For example, FIG. 2 illustrates that the machine-learning dispute system 102 determines relevant data (e.g., evidence) associated with a transaction dispute for use in prompting a large language model to determine the dispute resolution operation.

In one or more embodiments, the machine-learning dispute system 102 utilizes machine learning to determine how to resolve transaction disputes by intelligently extracting relevant data in connection with a request to dispute a transaction. Specifically, the machine-learning dispute system 102 receives a transaction dispute 200 including digital document(s) 202 that provide details associated with the transaction (e.g., evidence for the transaction dispute 200). Additionally, the machine-learning dispute system 102 utilizes one or more digital content analysis tools to determine extracted data 204 from the digital document(s) 202. As used herein, the term “digital document” refers to a computer file including data associated with a transaction or payment account involved in a transaction. For example, a digital document can include a digital image, a scanned document (e.g., PDF), or other computer file including evidence of a transaction, balance data for a payment account, or other data relevant to a transaction dispute. Additionally, a digital document can include any size or length, including one or more pages of digital content, a digital image of any resolution, etc.

Additionally, FIG. 2 illustrates that the machine-learning dispute system 102 generates model prompt(s) 206 to provide to a large language model 208 based on the extracted data 204. For instance, the machine-learning dispute system 102 generates a number and type(s) of model prompts for inputting to the large language model 208 to determine a dispute resolution operation 210. To illustrate, the machine-learning dispute system 102 determines whether to approve, deny, or require additional review of the transaction dispute 200 according to the outputs of the large language model 208, which can indicate whether the digital document(s) 202 provide sufficient evidence for the transaction dispute 200.

As used herein, the term “large language model” refers to an artificial intelligence model capable of processing and generating natural language text or other language-based prompts using language understanding. In particular, large language models are trained on large amounts of data to learn patterns and rules of language. As such, a large language model post-training is capable of generating output predictions that indicate visualization structures. Further, in some embodiments, a large language model includes or refers to one or more transformer-based neural networks capable of processing language-based prompts (e.g., natural language text) to generate outputs that range from predictive outputs, analyses, or combinations of data within stored content items. In particular, a large language model includes parameters trained (e.g., via deep learning) on large amounts of data to learn patterns and rules of language for summarizing and/or generating digital content. Examples of large language models include BLOOM, Bard AI, ChatGPT, LaMDA, DialoGPT.

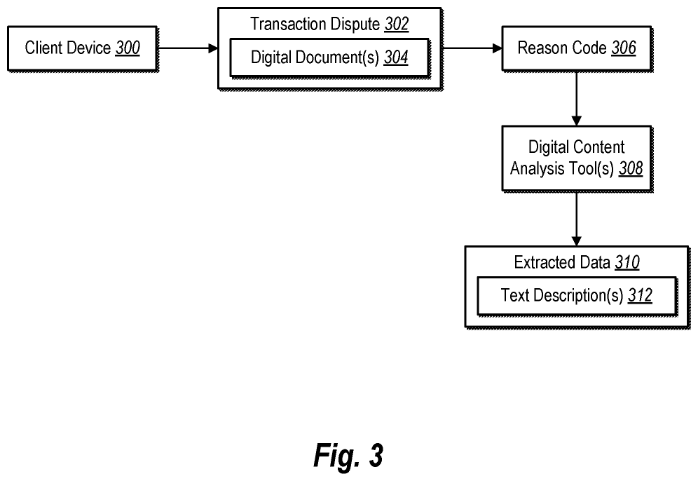

FIG. 3 illustrates additional detail for a process of extracting data from digital documents associated with a transaction dispute. In particular, as illustrated, the machine-learning dispute system 102 receives a request from a client device 300 indicating a transaction dispute 302. For example, the machine-learning dispute system 102 receives the request to dispute an electronic payment transaction from a user client device. To illustrate, the user client device can be a client device used to initiate the electronic payment transaction or a client device mapped to a payment account involved in the transaction. In additional embodiments, the client device 300 includes an agent client device disputing the transaction on behalf of a user or a merchant system. In further embodiments, the machine-learning dispute system 102 receives digital documents from a plurality of devices in connection with the transaction dispute 302 (e.g., from a cardholder device and a merchant device).

In one or more embodiments, the transaction dispute 302 includes digital document(s) 304 providing evidence for resolving the transaction dispute 302. For instance, the digital document(s) 304 can include a digital receipt, a transaction summary, account information, proof of delivery, a purchase order, or other documentation generated or modified in connection with initiating or processing a transaction. Additionally, as noted previously, the digital document(s) can be in various formats, such as, but not limited to, images, scanned documents, mixed media files, or text files.

In at least some embodiments, the machine-learning dispute system 102 parses the transaction dispute 302 (or a message indicating the transaction dispute 302) to determine metadata associated with the transaction dispute 302. For example, the machine-learning dispute system 102 can determine a reason code 306 for the transaction dispute 302 indicating a reason (e.g., selected from a predetermined set of reasons) for the dispute. To illustrate, the machine-learning dispute system 102 can extract (e.g., from a request including the transaction dispute 302) the reason code 306 indicating that the dispute is related to an undelivered product, a duplicate transaction, a product return, a defective item, fraud, lack of proper authorization, or other cause for a chargeback to a funding payment account. In some examples, the reason code 306 includes a numeric or alphabetic value specific to a payment card network to indicate the reason for disputing the transaction.

In one or more embodiments, the machine-learning dispute system 102 determines one or more tools to use in verifying the evidence for the transaction dispute 302. Specifically, the machine-learning dispute system 102 determines digital content analysis tool(s) 308 for processing the digital document(s) 304 associated with the transaction dispute 302. For example, the digital content analysis tool(s) 308 include, but are not limited to, software applications that perform optical character recognition operations, digital image analysis, PDF readers, or other digital document processing tools. The machine-learning dispute system 102 selects one or more digital content analysis tools based at least in part on the types of digital documents in the transaction dispute 302. The machine-learning dispute system 102 can also select one or more digital content analysis tools based on a user-selected tool type (e.g., in response to a selection of an OCR tool via a graphical user interface of an agent client device).

Additionally, in some embodiments, the machine-learning dispute system 102 selects the digital content analysis tool(s) 308 based on the reason code 306 (e.g., by determining one or more specific types of evidence required for the transaction dispute 302). For example, the digital document(s) 304 may include the same number of digital documents required for the given reason code 306 or more or fewer digital documents than are required for the given reason code 306. Accordingly, the machine-learning dispute system 102 can select the digital content analysis tool(s) 308 based on the types (e.g., file extensions) of digital documents in addition to digital data requirements associated with the reason code 306. To illustrate, the machine-learning dispute system 102 can select an OCR reader to analyze a digital image including a receipt of a transaction and a digital image processing model to analyze a digital image including proof of delivery (e.g., a photo of a package on a doorstep at a particular address).

As used herein, the term “digital content analysis tool” refers to a software application that extracts content from digital representations of data of one or more data types or media. For example, a digital content analysis tool includes a digital image processor, an OCR reader, a PDF reader, or a digital text analyzer that processes digital images, scanned documents, PDFs, text files, or other digital media to provide a description of the content. In some embodiments, a digital content analysis tool outputs a description of content of a digital document in a text format or in a software object readable by one or more software applications. Digital content analysis tools can also include machine-learning models.

In one or more embodiments, the machine-learning dispute system 102 determines extracted data 310 from the digital document(s) 304 using the digital content analysis tool(s) 308. In particular, the machine-learning dispute system 102 uses the digital content analysis tool(s) 308 to generate text description(s) 312 from the digital document(s) 304. For instance, the machine-learning dispute system 102 extracts text data from digital images, scanned documents, or other digital documents and generates separate files or metadata including the text description(s) 312 associated with the digital document(s) 304. In some embodiments, the machine-learning dispute system 102 generates XML documents including the text description(s) 312 for the digital document(s) 304. Additionally, the machine-learning dispute system 012 can map the text description(s) 312 (e.g., the metadata or files including the text description(s) 312) to the corresponding digital documents and store the mapping for later use (e.g., when providing information for display at an agent client device, a user client device, or merchant client device).

Additionally, the machine-learning dispute system 102 can also label or tag portions of text in the text description(s) 312 to indicate specific data types or contextual information about the digital content in the digital document(s) 304. For example, the machine-learning dispute system 012 can generate tags in the metadata or files to indicate line items, taxes, product IDs, account balances, or other information identified as a specific data type via one or more data tagging models, classifiers, or machine-learning models. In some embodiments, the machine-learning dispute system 102 also utilizes the digital content analysis tool(s) 308 to perform various transformations on the digital document(s) 304, such as rotating documents, performing image processing (e.g., sharpening, denoising, or cropping), or other operations to clean up or otherwise modify the content of the digital document(s) 304.

In one or more embodiments, the digital content analysis tool(s) 308 include machine-learning models to perform one or more operations on the digital document(s) 304. As used herein, the terms “machine-learning model” and “neural network” refer to a computer representation that is tunable (e.g., trained) based on inputs to approximate unknown functions used for generating corresponding outputs. In particular, in one or more embodiments, a machine learning model or a neural network is a computer-implemented model that utilizes algorithms to learn from, and make predictions on, known data by analyzing the known data to learn to generate outputs that reflect patterns and attributes of the known data. Additionally, a neural network can include a model of interconnected artificial neurons (e.g., organized in layers) that communicate and learn to approximate complex functions and generate outputs based on inputs. For instance, in some cases, a machine learning model includes, but is not limited to, a neural network (e.g., a convolutional neural network, recurrent neural network, or other deep learning network), a decision tree (e.g., a gradient boosted decision tree), support vector learning, Bayesian networks, a transformer-based model, a diffusion model, or a combination thereof. Accordingly, in some embodiments, a neural network for extracting data from a digital document can include a model that converts digital image data into hierarchical structures or text indicating relationships between components/concepts in the digital image data.

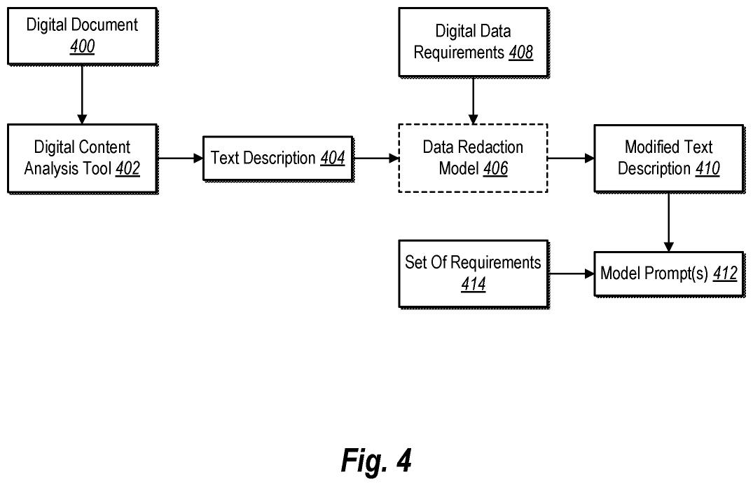

FIG. 4 illustrates a diagram of a process for generating one or more model prompts to provide to a large language model based on digital documents associated with a transaction dispute. In particular, FIG. 4 illustrates that the machine-learning dispute system 102 generates the model prompts based on data extracted from the digital documents and one or more requirements associated with the transaction dispute. Accordingly, the machine-learning dispute system 102 generates inputs for the large language model to determine how to resolve the transaction dispute.

In one or more embodiments, the machine-learning dispute system 102 determines a digital document 400 associated with a transaction dispute. Additionally, as previously mentioned, the machine-learning dispute system 102 utilizes a digital content analysis tool 402 to extract data from the digital document 400, including a text description 404 and/or other information associated with the digital document 400. For example, the machine-learning dispute system 102 generates or extracts metadata or contextual information about the digital document, such as timestamp information, geographical information, or location data associated with the digital document.

In at least some embodiments, the machine-learning dispute system 102 utilizes a data redaction model 406 to redact one or more data types from the text description 404 (or other extracted data). For instance, the digital documents may be subject to digital data requirements 408 that indicate how to handle such data types in electronic communications (e.g., personally identifiable information or other secure information covered by one or more regulations). To illustrate, the machine-learning dispute system 102 can utilize the data redaction model 406 to redact, obscure, or otherwise obfuscate specific data types detected in the text description 404 and generate a modified text description without the specific data types (e.g., by excluding the specific data types from the modified text description). In one or more embodiments, the machine-learning dispute system 102 utilizes a machine-learning model including a plurality of classifiers trained to identify one or more specific data types and redact the data types from the text description 404.

In response to generating the modified text description 410, the machine-learning dispute system 102 generates model prompt(s) 412 including the modified text description 410. In particular, the machine-learning dispute system 102 generates the model prompt(s) to include the modified text description 410 and any additional extracted data from digital documents associated with a transaction dispute. For example, the machine-learning dispute system 102 determines a plurality of text descriptions (or modified text descriptions excluding redacted data types) for a plurality of digital documents. The machine-learning dispute system 102 can thus generate a model prompt to indicate a text description corresponding to a particular digital document and include a query related to the text description (e.g., to determine whether the text description includes specific information that meets a threshold or a requirement).

Additionally, the machine-learning dispute system 102 can generate a number of model prompts based on various criteria associated with the transaction dispute. For instance, the machine-learning dispute system 102 can determine the number of model prompts to generate based on details or attributes of the transaction dispute (e.g., a transaction amount or a dispute amount), a reason code (e.g., a reason code such as “shipment not delivered” may be mapped to a specific number of model prompts), a user/merchant history of transactions or disputes, or additional prompts based on notes or memos generated at the time of creation of the transaction dispute. In various examples, the machine-learning dispute system 102 generates the model prompt(s) 412 based on the criteria above to include prompts such as “How much is the transaction amount in the receipt?” “What were the discounts?” “Where was the shipment delivered?” “When was the shipment delivered?” “Has this merchant been involved in fraudulent transactions?” “What is the dispute success rate for this user?” or other such prompts. Furthermore, as mentioned, the model prompt(s) 412 can include extracted and/or modified text descriptions of digital documents to provide to the large language model for responding to the prompts.

The machine-learning dispute system 102 can also determine the number of model prompts based a set of requirements 414 associated with the transaction dispute (e.g., a set of requirements mapped to a reason code). To illustrate, the machine-learning dispute system 102 can determine the set of requirements 414, which can indicate specific data types, data comparisons, thresholds, etc., in connection with the digital documents for resolving the transaction dispute. As an example, approval of a transaction dispute may require that the digital documents include a receipt with a total payment amount for comparison to a transaction amount of the corresponding electronic payment transaction. In other examples, the set of requirements 414 indicates that a purchase order, a proof of delivery, a product ID, a number of product units, etc., are required for a successful transaction dispute.

In one or more embodiments, the machine-learning dispute system 102 determines formatting of the model prompt(s) 412 based on the modified text description 410, the set of requirements 414, and/or the large language model. To illustrate, the machine-learning dispute system 102 utilizes the modified text description 410 to convert an output of a particular tool to a format that the machine-learning dispute system 102 passes to the large language model. In additional embodiments, the machine-learning dispute system 102 generates the model prompt(s) 412 including one or more natural language phrases to provide responses generated by the large language model based on extracted data from the digital documents. Furthermore, in some embodiments, the machine-learning dispute system 102 utilizes the digital content analysis tools (e.g., as in FIG. 3) to generate the model prompt(s) 412 in connection with extracting and classifying data from the digital document 400. In some embodiments, the machine-learning dispute system 102 also generates one or more model prompts based on input by a client device (e.g., a natural language question input by an agent client device).

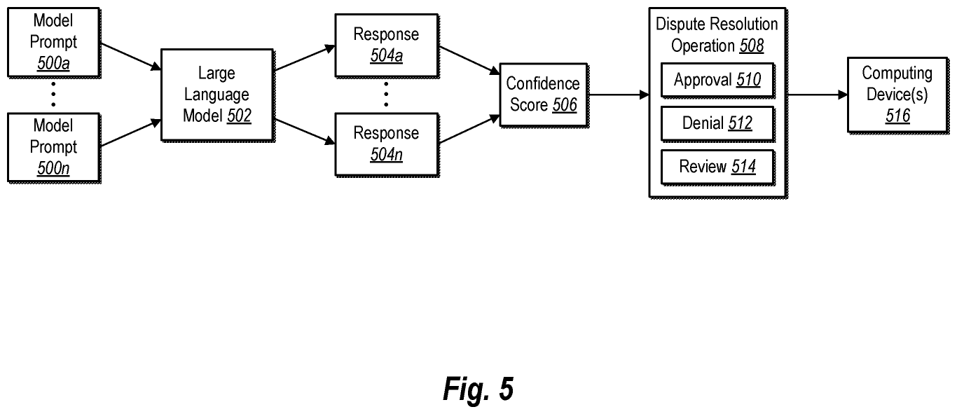

In one or more embodiments, the machine-learning dispute system 102 provides one or more model prompts generated based on digital documents for a transaction dispute to a large language model. FIG. 5 illustrates that the machine-learning dispute system 102 performs operations to determine how to resolve a transaction dispute utilizing a large language model. In particular, the machine-learning dispute system 102 utilizes the large language model to generate outputs based on prompts corresponding to digital documentation in a transaction dispute. The machine-learning dispute system 102 utilizes the outputs of the large language model to select the appropriate dispute resolution operation.

For example, as illustrated, the machine-learning dispute system 102 provides a plurality of model prompts 500a-500n to a large language model 502. In one or more embodiments, the large language model 502 includes a large-scale machine-learning model including deep learning layers for making decisions based on potentially large datasets. For example, the large language model 502 ingests the model prompts 500a-500n and generates a plurality of responses 504a-504n. To illustrate, the large language model 502 performs one or more language or text understanding operations to determine whether the contents of the digital documents associated with a transaction dispute meet various requirements for the transaction dispute. Furthermore, in some embodiments, the machine-learning dispute system 102 utilizes the large language model 502 to generate the responses 504a-504n based on the model prompts 500a-500n in combination with a set of requirements for resolving the transaction dispute (e.g., as described in FIG. 4). In one or more embodiments, the machine-learning dispute system 102 selects the large language model based on a selection of a particular model (e.g., based on input via a graphical user interface of an agent client device) and/or based on the prompt types of the model prompts 500a-500n.

In one or more embodiments, the responses 504a-504n include true-false responses for certain model prompts. For instance, a model prompt requesting that the large language model 502 determine whether the digital documents indicate that a purchase price for a particular transaction matches a payment amount in the corresponding transaction can result in the large language model 502 generating an output indicating that the prompt is true or false. In additional embodiments, the responses 504a-504n include additional analysis of one or more pieces of extracted data, such as an indication of various data types available in the digital documents. To illustrate, the responses 504a-504n can include an indication that the digital documents include a payment amount and a transaction ID but no proof of delivery. Furthermore, the responses 504a-504n can include comparisons of specific values to one or more thresholds.

In one or more embodiments, as illustrated in FIG. 5, the machine-learning dispute system 102 generates a confidence score 506 for resolving a transaction dispute. Specifically, the machine-learning dispute system 102 can utilize the responses 504a-504n to determine confidence scores associated with one or more decisions for how to resolve the transaction dispute (e.g., by indicating whether the digital documents meet a set of requirements). As an example, the machine-learning dispute system 102 determines, based on the responses 504a-504n, whether the transaction dispute should be approved according to whether the digital documents provided with the transaction dispute meets one or more requirements. The machine-learning dispute system 102 can also generate the confidence score 506 for the approval of the transaction dispute, such as by combining confidence scores associated with the responses 504a-504n (e.g., based on confidence data output by the large language model 502 for each response or based on confidence scores generated by an additional machine-learning model for the responses 504a-504n).

In some embodiments, the machine-learning dispute system 102 utilizes additional information to generate the confidence score 506 (or to otherwise determine an action to take in response to the transaction dispute. For example, the machine-learning dispute system 102 can access a user history 505 associated with a requester of the transaction dispute to determine previous transaction disputes initiated by the requester (or other previous data). The machine-learning dispute system 102 can use the user history 505 to determine a likelihood of the transaction dispute resulting in approval. In various instances, the user history 505 can correspond to a consumer user (e.g., a cardholder) or a merchant system.

To illustrate, in response to determining that the user history 505 includes a threshold percentage (or a threshold number) of previously approved transaction disputes, the machine-learning dispute system 102 can increase the confidence score 506. Alternatively, in response to determining that the user history 505 includes less than the threshold percentage of previously approved transaction disputes or a threshold percentage of previously denied transaction disputes, the machine-learning dispute system 102 can decrease the confidence score 506. In additional embodiments, the machine-learning dispute system 102 can determine an indicator that a particular user history 505 indicates frequent transaction disputes indicating fraudulent chargeback requests in response to reaching a threshold number (or percentage) of denied transaction disputes and flag the user history 505. Thus, for subsequent transaction disputes, the machine-learning dispute system 102 can identify the flag in the user history 505 and automatically deny the transaction dispute. In some embodiments, the machine-learning dispute system 102 checks the user history 505 for such a flag prior to communicating with the large language model 502 to avoid unnecessary operations in response to determining that the requester is flagged for frequent fraudulent activity.

Additionally, in some embodiments, the machine-learning dispute system 102 compares the confidence score 506 to one or more thresholds. In particular, the machine-learning dispute system 102 can compare the confidence score 506 to one or more thresholds in a decision tree comprising leaf nodes/classifiers associated with possible operations for a dispute resolution operation 508. For instance, the machine-learning dispute system 102 compares the confidence score 506 to a first threshold corresponding to an approval 510 of the transaction dispute. To illustrate, in response to the confidence score 506 being above the first threshold, the machine-learning dispute system 102 selects the approval 510 as the dispute resolution operation 508. In one or more embodiments, the approval 510 indicates that the digital documents of the transaction dispute meet a set of requirements for the transaction dispute.

Additionally, the machine-learning dispute system 102 can compare the confidence score 506 to a second threshold corresponding to a denial 512 of the transaction dispute. For example, in response to the confidence score 506 being below the second threshold, the machine-learning dispute system 102 selects the denial 512 as the dispute resolution operation 508. In various embodiments, the second threshold is the same as the first threshold. Alternatively, the second threshold is below the first threshold (e.g., the first threshold corresponds to a 90% confidence value and the second threshold corresponds to an 80% confidence value). In one or more embodiments, the denial 616 indicates that the digital documents of the transaction dispute do not meet a set of requirements for the transaction dispute.

In additional embodiments, the machine-learning dispute system 102 compares the confidence score 506 to the first threshold and the second threshold in connection with a review 514 of the transaction dispute. Specifically, in response to the confidence score 506 being between the first threshold and the second threshold, the machine-learning dispute system 102 selects the review 514 (e.g., review by an agent user via an agent computing device) as the dispute resolution operation 508. To illustrate, the machine-learning dispute system 102 determines that the confidence score 506 is below the first threshold and above the second threshold, indicating uncertainty in the decision by the machine-learning dispute system 102. In alternative embodiments, the machine-learning dispute system 102 generates separate confidence scores for each possible dispute resolution operation (e.g., a first confidence score for approval 510, a second confidence score for denial 512, and a third confidence score for review 514) and selects the option with the highest confidence score.

Additionally, as illustrated in FIG. 5, the machine-learning dispute system 102 provides information associated with the dispute resolution operation 508 to computing device(s) 516. For example, the machine-learning dispute system 102 performs one or more dispute resolution operations for a transaction dispute and provides an indication of the performed operation(s) to the computing device(s) 516. The machine-learning dispute system 102 can alternatively provide a request to the computing device(s) to perform the dispute resolution operation 508. In some embodiments, the computing device(s) 516 include a computing device that initiated the transaction dispute, such as a merchant device or a user client device. The computing device(s) 516 can also include a computing device involved in resolving the transaction dispute, such as an agent client device.

In additional embodiments, the machine-learning dispute system 102 provides a notification to an agent client device in connection with selecting the review 514 as the dispute resolution operation 508. In particular, in response to determining that the transaction dispute requires additional review (e.g., based on uncertain confidence), the machine-learning dispute system 102 generates a message to provide to the agent client device including details associated with the transaction dispute. For example, the machine-learning dispute system 102 generates a message including relevant information of the transaction dispute for review by an agent user of the agent client device for resolving the transaction dispute.

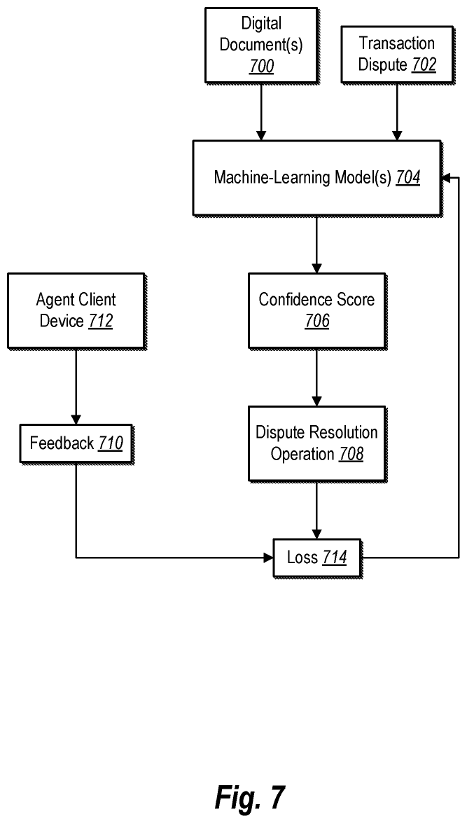

In one or more embodiments, the machine-learning dispute system 102 utilizes a machine-learning model to determine the dispute resolution operation 508 based on the outputs of the large language model 502. For example, the machine-learning dispute system 102 can utilize a machine-learning model trained on past decisions and/or feedback associated with previous transaction disputes. FIG. 7 and the corresponding description provide additional detail associated with training a machine-learning model to determine a dispute resolution operation for a transaction dispute. The machine-learning dispute system 102 can thus utilize automated processes for resolving transaction disputes that learns and improves over time.

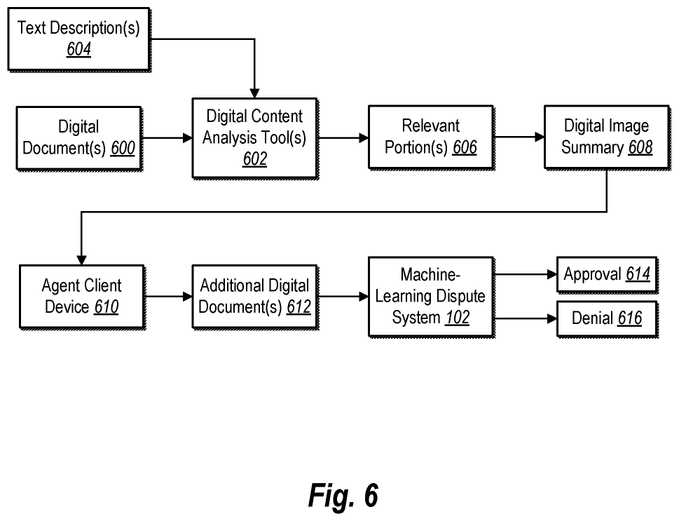

For example, FIG. 6 illustrates a diagram of a process for presenting relevant information from a transaction dispute for review. Specifically, as illustrated, the machine-learning dispute system 102 processes evidence for the transaction dispute to identify and highlight or otherwise mark relevant information for the review. Additionally, the machine-learning dispute system 102 can prompt a submitter to provide additional documentation/evidence for resolving a transaction dispute after review.

In one or more embodiments, in connection with a review process for a transaction dispute, the machine-learning dispute system 102 determines digital document(s) 600 associated with the transaction dispute. For example, the digital document(s) 600 include one or more files uploaded or otherwise sent to the machine-learning dispute system 102 by a computing device that initiated the transaction dispute. The machine-learning dispute system 102 can also utilize digital content analysis tool(s) 602 to process the digital document(s) 600 for use in the review process. To illustrate, the machine-learning dispute system 102 can utilize the same digital content analysis tools previously used in connection with extracting data from the digital document(s) 600.

In some embodiments, the machine-learning dispute system 102 obtains text description(s) 604 of the digital document(s) 600, in addition to any other extracted or related information, for use in the review process. For instance, the machine-learning dispute system 102 can store text descriptions obtained utilizing the digital content analysis tool(s) 602 during the data extraction operations. Thus, the machine-learning dispute system 102 can utilize the previously extracted data to determine relevant data for the review process.

According to one or more embodiments, the machine-learning dispute system 102 determines relevant portion(s) 606 of the digital document(s) 600 relevant to the review process. In particular, the machine-learning dispute system 102 determines the relevant portion(s) 606 including one or more portions of the digital document(s) 600 (e.g., by utilizing the text description(s) 604) provided with the transaction dispute that may include insufficient or inaccurate evidence according to requirements of the transaction dispute. For example, the machine-learning dispute system 102 can determine that the digital document(s) 600 include an incorrect document, obscured information (e.g., blurry or poor image quality), or other portions of the digital document(s) 600 that cause a low confidence score in connection with determining a dispute resolution operation.

In response to determining the relevant portion(s) 606, the machine-learning dispute system 102 can highlight the information. For example, FIG. 6 illustrates that the machine-learning dispute system 102 generates a digital image summary 608 based on the relevant portion(s) 606. To illustrate, the machine-learning dispute system 102 generates the digital image summary 608 by highlighting the relevant portion(s) 606 in the digital document(s) 600. As an example, the machine-learning dispute system 102 determines a relevant portion (e.g., a payment amount) of a digital image including a receipt based on a text description of the digital image and highlights the relevant portion of the digital image. The machine-learning dispute system 102 can thus highlight the relevant portion(s) 606 by modifying digital images, scanned documents, etc., and/or by copying the digital document(s) 600 and modifying the copies. Additionally, in some embodiments, the machine-learning dispute system 102 automatically crops the digital document(s) 600 to the relevant portion(s) 606 (e.g., by generating a cropped version of a digital document) to include in the digital image summary 608, thereby consolidating and simplifying the relevant information for the review process.

In one or more embodiments, the machine-learning dispute system 102 also provides a recommendation with the digital image summary 608. For example, based on a confidence score generated by the machine-learning dispute system 102 associated with the transaction dispute, the machine-learning dispute system 102 can determine a particular dispute resolution operation. The machine-learning dispute system 102 can generate a message including a recommendation to perform the dispute resolution operation, along with one or more options to implement (e.g., execute) the dispute resolution operation or to change the dispute resolution operation (e.g., to select a new dispute resolution operation).

Furthermore, in some embodiments, the digital image summary 608 is interactive. For instance, the machine-learning dispute system 102 can generate the digital image summary 608 including links for the relevant portion(s) 606 to the corresponding locations in the digital document(s) 600. To illustrate, the machine-learning dispute system 102 can generate a hyperlink for a relevant portion of a digital image or a PDF that, upon selection, causes an agent client device 610 to navigate to the corresponding location in the digital image or PDF. Thus, the machine-learning dispute system 102 can provide an improved graphical user interface for quickly navigating to relevant portions of digital documents (e.g., to allow for further analysis of context related to the relevant portions) during a review process.

The machine-learning dispute system 102 can provide the digital image summary 608 to the agent client device 610 for an agent user to review. In particular, the machine-learning dispute system 102 can provide the digital image summary 608 including the relevant portion(s) 606 for display at the agent client device 610. The agent client device 610 can display the digital image summary 608 with one or more tools for reviewing the relevant portion(s) 606 and/or digital document(s) 600 with details of the transaction dispute.

In some embodiments, as illustrated in FIG. 6, the machine-learning dispute system 102 also determines additional digital document(s) 612 for the transaction dispute based on one or more interactions via the agent client device 610. For example, the agent client device 610 can send (or initiate a process to send) a message to a computing device that initiated the transaction dispute (or a computing device of an interested party) requesting more information or evidence for the transaction dispute. To illustrate, in response to the transaction dispute not including a specific digital document (e.g., a proof of delivery) or including the incorrect digital document, the agent client device 610 can initiate a process to request more documentation for the transaction dispute.

Additionally, in response to receiving the additional digital document(s) 612 (e.g., from a user device, a merchant device, or the agent client device 610), the machine-learning dispute system 102 can further process the additional digital document(s) 612 to determine a dispute resolution operation. For example, the machine-learning dispute system 102 can extract data from the additional digital document(s) 612 and use the extracted data to determine a new dispute resolution operation. To illustrate, the machine-learning dispute system 102 can determine that the new evidence results in approval 614 of the transaction dispute. Alternatively, the machine-learning dispute system 102 can determine that the new evidence results in denial 616 of the transaction dispute. In additional embodiments, the agent client device 610 resolves the transaction dispute by executing a dispute resolution operation to approve or deny the transaction dispute without further processing by the machine-learning dispute system 102 and communicating with one or more computing devices (e.g., a payment network, a user client device, or a merchant client device) in response to receiving the additional digital document(s) 612.

As mentioned, in one or more embodiments, the machine-learning dispute system 102 utilizes a machine-learning model to determine dispute resolution operations for transaction disputes. FIG. 7 illustrates that the machine-learning dispute system 102 learns to automatically determine and execute dispute resolution operations based on feedback. Specifically, the machine-learning dispute system 102 can include one or more machine-learning models for utilizing outputs of a large language model to determine whether to approve or deny transaction disputes.

In one or more embodiments, as illustrated, the machine-learning dispute system 102 determines digital document(s) 700 for a transaction dispute 702. The machine-learning dispute system 102 utilizes machine-learning model(s) 704 to process the digital document(s) 700 and generate a confidence score 706 associated with a decision for the transaction dispute 702. Based on the confidence score 706, the machine-learning dispute system 102 chooses a dispute resolution operation 708 (e.g., approval, denial, or review) utilizing the machine-learning model(s) 704. In one or more embodiments, the machine-learning model(s) 704 include a regression model, a convolutional neural network, or a neural network including an encoder-decoder architecture to encode features of the digital document(s) 700 and the transaction dispute 702 to determine the dispute resolution operation 708.

Furthermore, the machine-learning dispute system 102 receives feedback 710 for the dispute resolution operation 708, such as by communicating with an agent client device 712. In particular, the machine-learning dispute system 102 can provide an indication of the transaction dispute 702 with the digital document(s) 700 to the agent client device 712 for review. The machine-learning dispute system 102 can receive the feedback 710 indicating whether to approve or deny the transaction dispute 702.

Additionally, the machine-learning dispute system 102 can compare the feedback 710 to the dispute resolution operation 708 to determine a loss 714. To illustrate, the machine-learning dispute system 102 determines the loss 714 based on a difference between the confidence score 706 of the dispute resolution operation 708 generated by the machine-learning model(s) 704 and a confidence score associated with the feedback 710. In one or more embodiments, the machine-learning dispute system 102 assigns a confidence score to the feedback 710 (e.g., 100% indicating approval or 0% indicating denial) indicating that the feedback 710 represents a ground truth. In alternative embodiments, the machine-learning dispute system 102 assigns binary (or ternary) values to possible dispute resolution operations (e.g., a first value for approval, a second value for denial, and a third value for review) and compares the corresponding value of the dispute resolution operation 708 to the value of the feedback 710 (e.g., the first value for approval or the second value for denial).

The machine-learning dispute system 102 can use the loss 714 to train the machine-learning model(s) 704. For instance, the machine-learning dispute system 102 provides the loss 714 to the machine-learning model(s) 704 and uses backpropagation or other training method to learn parameters of the machine-learning model(s) 704. Accordingly, training the machine-learning model(s) 704 results in reducing the difference between a predicted dispute resolution operation and the feedback 710 provided by the agent client device 712. In particular, generating an updated dispute resolution operation for the transaction dispute 702 results in the machine-learning model(s) 704 results in a smaller (or no) difference between the updated resolution operation and the feedback 710. In some embodiments, training the machine-learning model(s) 704 can also include changing requirements for reason codes, numbers of model prompts for reason codes, or other attributes that affect whether the machine-learning model(s) 704 determine to approve or deny a particular transaction dispute.

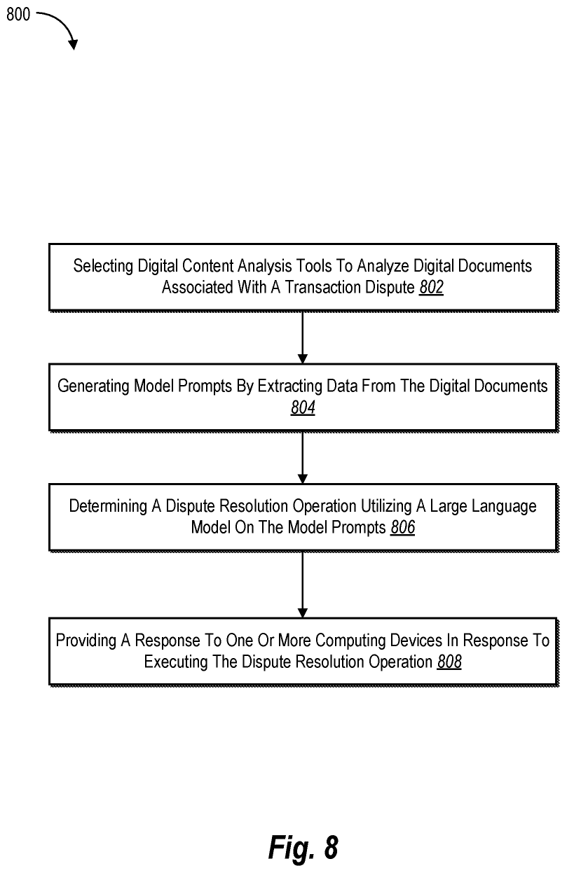

Turning now to FIG. 8, this figure shows a flowchart of a series of acts 800 of utilizing intelligent digital content analysis and a large language model to resolve a transaction dispute. While FIG. 8 illustrates acts according to one embodiment, alternative embodiments may omit, add to, reorder, and/or modify any of the acts shown in FIG. 8. The acts of FIG. 8 can be performed as part of a method. Alternatively, a non-transitory computer readable storage medium can comprise instructions, that when executed by one or more processors, cause a computing device to perform the acts of FIG. 8. In still further embodiments, a system can perform the acts of FIG. 8.

As shown in FIG. 8, the series of acts 800 includes an act 802 of selecting digital content analysis tools to analyze digital documents associated with a transaction dispute. Additionally, the series of acts 800 includes an act 804 of generating model prompts by extracting data from the digital documents. The series of acts 800 also includes an act 806 of determining a dispute resolution operation utilizing a large language model on the model prompts. Furthermore, the series of acts 800 includes an act 808 of providing a response to one or more computing devices in response to executing the dispute resolution operation.

For example, act 802 involves selecting, based on attributes of a request comprising an indication of a transaction dispute for a transaction, one or more digital content analysis tools to analyze one or more digital documents including details of the transaction. Act 804 involves generating one or more model prompts by extracting data associated with the transaction from the one or more digital documents utilizing the one or more digital content analysis tools. Act 806 involves determining, utilizing a large language model, a dispute resolution operation from a plurality of dispute resolution operations according to the one or more model prompts. Additionally, act 808 involves providing, in response to executing the dispute resolution operation, a response to the request to one or more computing devices associated with the request.

In one or more embodiments, the series of acts 800 includes selecting the one or more digital content analysis tools by extracting, from the request, a reason code associated with the transaction dispute; and selecting the one or more digital content analysis tools based on the reason code. The series of acts 800 can also include determining a set of requirements for resolving the transaction dispute according to the reason code; and determining, utilizing the large language model, the dispute resolution operation according to the set of requirements and the one or more digital documents.

The series of acts 800 can include determining the dispute resolution operation according to the set of requirements by approving, based on one or more responses by the large language model to the one or more model prompts, the transaction dispute in response to determining that the one or more digital documents meet the set of requirements. The series of acts 800 can also include determining the dispute resolution operation according to the set of requirements by denying, based on the one or more responses by the large language model to the one or more model prompts, the transaction dispute in response to determining that the one or more digital documents do not meet the set of requirements.

In one or more embodiments, the series of acts 800 includes generating the one or more model prompts by generating one or more text descriptions of the data extracted from the one or more digital documents. The series of acts 800 can also include determining the dispute resolution operation by generating one or more responses to the one or more model prompts utilizing the large language model. The series of acts 800 can further include generating a confidence score based on the one or more responses relative to a set of requirements for resolving the transaction dispute. Also, the series of acts 800 can include selecting the dispute resolution operation from the plurality of dispute resolution operations based on the confidence score and a decision tree including the plurality of dispute resolution operations.

In some embodiments, the series of acts 800 includes generating the one or more model prompts by detecting, in the one or more text descriptions of the data extracted from the one or more digital documents, one or more data types indicated by digital data requirements. The series of acts 800 can also include generating the one or more model prompts by redacting, utilizing a data redaction model, the one or more data types from the one or more text descriptions of the data extracted from the one or more digital documents prior to providing the one or more model prompts to the large language model.

In one or more embodiments, the series of acts 800 includes generating the one or more model prompts by determining a number of model prompts to generate based on a number of the one or more digital documents, transaction details related to a transaction amount, or a reason code associated with the transaction dispute.

According to one or more embodiments, the series of acts 800 includes determining, in connection with one or more responses generated by the large language model, one or more relevant portions of the one or more digital documents for the dispute resolution operation. The series of acts 800 can also include generating a digital image summary marking the one or more relevant portions of the one or more digital documents. Additionally, the series of acts 800 can include providing the digital image summary to the one or more computing devices associated with the request.

In some embodiments, the series of acts 800 also include providing, for display at the one or more computing devices, one or more options to upload an additional digital document for the request based on a response generated by the large language model for the one or more model prompts. The series of acts 800 can further include executing the dispute resolution operation in response to receiving the additional digital document from the one or more computing devices.

In one or more embodiments, the series of acts 800 includes selecting the one or more digital content analysis tools based on a reason code indicated in the request. The series of acts 800 can also include determining a set of requirements mapped to the reason code. The series of acts 800 can further include determining a user history associated with a requester of the transaction dispute, the user history indicating one or more previous transaction disputes. The series of acts 800 can include generating, based on one or more responses by the large language model to the one or more model prompts and the one or more previous transaction disputes of the user history, a confidence score indicating that the one or more digital documents meet the set of requirements. The series of acts 800 can further include determining, based on the confidence score and a decision tree comprising thresholds for the plurality of dispute resolution operations, the dispute resolution operation according to the set of requirements and the one or more digital documents.

In one or more embodiments, the series of acts 800 includes determining the dispute resolution operation to approve the transaction dispute in response to the confidence score meeting a threshold of the decision tree. The series of acts 800 can also include executing the dispute resolution operation to approve the transaction dispute.

Additionally, the series of acts 800 can include determining the dispute resolution operation to provide the request to the one or more computing devices the transaction dispute in response to the confidence score meeting a first threshold of the decision tree and not meeting a second threshold of the decision tree. The series of acts 800 can also include executing the dispute resolution operation by: generating a message comprising an indication of the transaction dispute and one or more portions of the one or more digital documents; and providing the message comprising the indication of the transaction dispute for display at the one or more computing devices. For example, the series of acts 800 can include generating the message by: determining, in connection with the one or more responses generated by the large language model, one or more relevant portions of a digital document of the one or more digital documents for the dispute resolution operation; and generating a cropped version of the digital document including the one or more relevant portions.

In one or more embodiments, the series of acts 800 includes generating the one or more model prompts by: detecting, in one or more text descriptions of data extracted from the one or more digital documents, one or more data types indicated by digital data requirements associated with the transaction dispute; and redacting the one or more data types from the one or more text descriptions of the data extracted from the one or more digital documents. The series of acts 800 also includes providing the one or model prompts comprising the one or more text descriptions without the one or more data types to the large language model.

In one or more embodiments, the series of acts 800 includes extracting, from the request, a reason code associated with the transaction dispute. The series of acts 800 can also include selecting the one or more digital content analysis tools based on the reason code. The series of acts 800 can include extracting data from the one or more digital documents utilizing the one or more digital content analysis tools.

Additionally, the series of acts 800 can include generating the one or more model prompts by: generating, utilizing the one or more digital content analysis tools, text descriptions of data in the one or more digital documents; redacting one or more data types from the text descriptions of the data in the one or more digital documents; and generating the one or more model prompts based on a set of requirements associated with the transaction dispute. The series of acts 800 can further include determining the dispute resolution operation by: generating a confidence score based on one or more responses by the large language model to the one or more model prompts; and determining the dispute resolution operation based on the confidence score and a plurality of thresholds associated with the plurality of dispute resolution operations.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 9 illustrates a block diagram of exemplary computing device 900 that may be configured to perform one or more of the processes described above. One will appreciate that one or more computing devices such as the computing device 900 may implement the system(s) of FIG. 1. As shown by FIG. 9, the computing device 900 can comprise a processor 902, a memory 904, a storage device 906, an I/O interface 908, and a communication interface 910, which may be communicatively coupled by way of a communication infrastructure 912. In certain embodiments, the computing device 900 can include fewer or more components than those shown in FIG. 9. Components of the computing device 900 shown in FIG. 9 will now be described in additional detail.

In one or more embodiments, the processor 902 includes hardware for executing instructions, such as those making up a computer program. As an example, and not by way of limitation, to execute instructions for dynamically modifying workflows, the processor 902 may retrieve (or fetch) the instructions from an internal register, an internal cache, the memory 904, or the storage device 906 and decode and execute them. The memory 904 may be a volatile or non-volatile memory used for storing data, metadata, and programs for execution by the processor(s). The storage device 906 includes storage, such as a hard disk, flash disk drive, or other digital storage device, for storing data or instructions for performing the methods described herein.

The I/O interface 908 allows a user to provide input to, receive output from, and otherwise transfer data to and receive data from computing device 900. The I/O interface 908 may include a mouse, a keypad or a keyboard, a touch screen, a camera, an optical scanner, network interface, modem, other known I/O devices or a combination of such I/O interfaces. The I/O interface 908 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 908 is configured to provide graphical data to a display for presentation to a user. The graphical data may be representative of one or more graphical user interfaces and/or any other graphical content as may serve a particular implementation.

The communication interface 910 can include hardware, software, or both. In any event, the communication interface 910 can provide one or more interfaces for communication (such as, for example, packet-based communication) between the computing device 900 and one or more other computing devices or networks. As an example, and not by way of limitation, the communication interface 910 may include a network interface controller (NIC) or network adapter for communicating with an Ethernet or other wire-based network or a wireless NIC (WNIC) or wireless adapter for communicating with a wireless network, such as a WI-FI.

Additionally, the communication interface 910 may facilitate communications with various types of wired or wireless networks. The communication interface 910 may also facilitate communications using various communication protocols. The communication infrastructure 912 may also include hardware, software, or both that couples components of the computing device 900 to each other. For example, the communication interface 910 may use one or more networks and/or protocols to enable a plurality of computing devices connected by a particular infrastructure to communicate with each other to perform one or more aspects of the processes described herein. To illustrate, the digital content campaign management process can allow a plurality of devices (e.g., a client device and server devices) to exchange information using various communication networks and protocols for sharing information such as electronic messages, user interaction information, engagement metrics, or campaign management resources.

In the foregoing specification, the present disclosure has been described with reference to specific exemplary embodiments thereof. Various embodiments and aspects of the present disclosure(s) are described with reference to details discussed herein, and the accompanying drawings illustrate the various embodiments. The description above and drawings are illustrative of the disclosure and are not to be construed as limiting the disclosure. Numerous specific details are described to provide a thorough understanding of various embodiments of the present disclosure.

The present disclosure may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

What is claimed is:

1. A computer-implemented method comprising:
selecting, by one or more processors and based on attributes of a request comprising an indication of a transaction dispute for a transaction, one or more digital content analysis tools to analyze one or more digital documents including details of the transaction;
generating, by the one or more processors, one or more model prompts by extracting data associated with the transaction from the one or more digital documents utilizing the one or more digital content analysis tools;
determining, by the one or more processors utilizing a large language model, a dispute resolution operation from a plurality of dispute resolution operations according to the one or more model prompts; and
providing, by the one or more processors and in response to executing the dispute resolution operation, a response to the request to one or more computing devices associated with the request.

2. The computer-implemented method of claim 1, wherein selecting the one or more digital content analysis tools comprises:
extracting, from the request, a reason code associated with the transaction dispute; and
selecting the one or more digital content analysis tools based on the reason code.

3. The computer-implemented method of claim 2, further comprising:
determining a set of requirements for resolving the transaction dispute according to the reason code; and
determining, utilizing the large language model, the dispute resolution operation according to the set of requirements and the one or more digital documents.

4. The computer-implemented method of claim 3, wherein determining the dispute resolution operation according to the set of requirements comprises:
approving, based on one or more responses by the large language model to the one or more model prompts, the transaction dispute in response to determining that the one or more digital documents meet the set of requirements; or
denying, based on the one or more responses by the large language model to the one or more model prompts, the transaction dispute in response to determining that the one or more digital documents do not meet the set of requirements.

5. The computer-implemented method of claim 1, wherein:
generating the one or more model prompts comprises generating one or more text descriptions of the data extracted from the one or more digital documents; and
determining the dispute resolution operation comprises:
generating one or more responses to the one or more model prompts utilizing the large language model;
generating a confidence score based on the one or more responses relative to a set of requirements for resolving the transaction dispute; and
selecting the dispute resolution operation from the plurality of dispute resolution operations based on the confidence score and a decision tree including the plurality of dispute resolution operations.

6. The computer-implemented method of claim 5, wherein generating the one or more model prompts comprises:
detecting, in the one or more text descriptions of the data extracted from the one or more digital documents, one or more data types indicated by digital data requirements; and
redacting, utilizing a data redaction model, the one or more data types from the one or more text descriptions of the data extracted from the one or more digital documents prior to providing the one or more model prompts to the large language model.

7. The computer-implemented method of claim 1, wherein generating the one or more model prompts comprises determining a number of model prompts to generate based on a number of the one or more digital documents, transaction details related to a transaction amount, or a reason code associated with the transaction dispute.

8. The computer-implemented method of claim 1, further comprising:
determining, in connection with one or more responses generated by the large language model, one or more relevant portions of the one or more digital documents for the dispute resolution operation;
generating a digital image summary marking the one or more relevant portions of the one or more digital documents; and
providing the digital image summary to the one or more computing devices associated with the request.

9. The computer-implemented method of claim 8, further comprising:
providing, for display at the one or more computing devices, one or more options to upload an additional digital document for the request based on a response generated by the large language model for the one or more model prompts; and
executing the dispute resolution operation in response to receiving the additional digital document from the one or more computing devices.

10. A system comprising:
one or more non-transitory computer readable media; and
at least one processor configured to cause the system to:
select, based on attributes of a request comprising an indication of a transaction dispute for a transaction, one or more digital content analysis tools to analyze one or more digital documents including details of the transaction;
generate one or more model prompts by extracting data associated with the transaction from the one or more digital documents utilizing the one or more digital content analysis tools;
determine, utilizing a large language model, a dispute resolution operation from a plurality of dispute resolution operations according to the one or more model prompts; and
provide, in response to executing the dispute resolution operation, a response to the request to a computing device associated with the request.

11. The system of claim 10, wherein the at least one processor is configured to cause the system to select the one or more digital content analysis tools based on a reason code indicated in the request.

12. The system of claim 11, wherein the at least one processor is configured to cause the system to:
determine a set of requirements mapped to the reason code;
determine a user history associated with a requester of the transaction dispute, the user history indicating one or more previous transaction disputes;
generate, based on one or more responses by the large language model to the one or more model prompts and the one or more previous transaction disputes of the user history, a confidence score indicating that the one or more digital documents meet the set of requirements; and
determine, based on the confidence score and a decision tree comprising thresholds for the plurality of dispute resolution operations, the dispute resolution operation according to the set of requirements and the one or more digital documents.

13. The system of claim 12, wherein the at least one processor is configured to cause the system to:
determine the dispute resolution operation to approve the transaction dispute in response to the confidence score meeting a threshold of the decision tree; and
execute the dispute resolution operation to approve the transaction dispute.

14. The system of claim 12, wherein the at least one processor is configured to cause the system to:
determine the dispute resolution operation to deny the transaction dispute in response to the confidence score not meeting a threshold of the decision tree; and
execute the dispute resolution operation to deny the transaction dispute.

15. The system of claim 12, wherein the at least one processor is configured to cause the system to:
determine the dispute resolution operation to provide the request to the computing device the transaction dispute in response to the confidence score meeting a first threshold of the decision tree and not meeting a second threshold of the decision tree; and
execute the dispute resolution operation by:
generating a message comprising an indication of the transaction dispute and one or more portions of the one or more digital documents; and
providing the message comprising the indication of the transaction dispute for display at the computing device.

16. The system of claim 15, wherein the at least one processor is configured to cause the system to generate the message by:
determining, in connection with the one or more responses generated by the large language model, one or more relevant portions of a digital document of the one or more digital documents for the dispute resolution operation; and
generating a cropped version of the digital document including the one or more relevant portions.

17. The system of claim 12, wherein the at least one processor is configured to cause the system to:
generate the one or more model prompts by:
detecting, in one or more text descriptions of data extracted from the one or more digital documents, one or more data types indicated by digital data requirements associated with the transaction dispute; and
redacting the one or more data types from the one or more text descriptions of the data extracted from the one or more digital documents; and
provide the one or model prompts comprising the one or more text descriptions without the one or more data types to the large language model.

18. A non-transitory computer readable medium comprising instructions that, when executed by at least one processor, cause the at least one processor to:
select, based on attributes of a request comprising an indication of a transaction dispute for a transaction, one or more digital content analysis tools to analyze one or more digital documents including details of the transaction;
generate one or more model prompts by extracting data associated with the transaction from the one or more digital documents utilizing the one or more digital content analysis tools;
determine, utilizing a large language model, a dispute resolution operation from a plurality of dispute resolution operations according to the one or more model prompts; and
provide, in response to executing the dispute resolution operation, a response to the request to a computing device associated with the request.

19. The non-transitory computer readable medium of claim 18, wherein the instructions that, when executed by the at least one processor, cause the at least one processor to:
extract, from the request, a reason code associated with the transaction dispute;
select the one or more digital content analysis tools based on the reason code; and
extract data from the one or more digital documents utilizing the one or more digital content analysis tools.

20. The non-transitory computer readable medium of claim 18, wherein the instructions that, when executed by the at least one processor, cause the at least one processor to:
generate the one or more model prompts by:
generating, utilizing the one or more digital content analysis tools, text descriptions of data in the one or more digital documents;
redacting one or more data types from the text descriptions of the data in the one or more digital documents; and
generating the one or more model prompts based on a set of requirements associated with the transaction dispute; and
determine the dispute resolution operation by:
generating a confidence score based on one or more responses by the large language model to the one or more model prompts; and
determining the dispute resolution operation based on the confidence score and a plurality of thresholds associated with the plurality of dispute resolution operations.
